(19) United States
(12) Patent Application Publication
(10) Pub. No.: US 2025/0203649 A1
(43) Pub. Date: Jun. 19, 2025

(54) METHOD FOR COMMUNICATION IN COMMUNICATION SYSTEM AND APPARATUS THEREOF

(71) Applicant: Samsung Electronics Co., Ltd., Gyeonggi-do (KR)

(72) Inventors: Min WU, Beijing (CN); Feifei SUN, Beijing (CN); Sa ZHANG, Beijing (CN)

(21) Appl. No.: 18/852,051

(22) PCT Filed: Mar. 21, 2023
(86) PCT No.: PCT/KR2023/003704

§ 371 Date: Sep. 27, 2024

(30) Foreign Application Priority Data
Mar. 31, 2022 (CN) 202210346124.X

(51) Int. Cl. H04W 74/00; H04W 74/0833; H04W 76/28

(52) U.S. Cl. CPC H04W 74/006; H04W 74/0833; H04W 76/28

(57) ABSTRACT

The disclosure relates to a 5G or 6G communication system for supporting a higher data transmission rate. Embodiments of the disclosure provide a communication method, a user equipment, a base station, and a storage medium. The method includes: determining at least two kinds of periods of a signal; and receiving or transmitting the signal based on the at least two kinds of periods. Embodiments of the disclosure can reduce a proportion of periodic signals, thereby reducing power consumption of a communication base station.

### TECHNICAL FIELD

The disclosure relates to a field of wireless communication technology, and in particular, the disclosure relates to a communication method, a user equipment (UE), a base station, and a storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The embodiments of the disclosure may provide a method and apparatus to reduce the power consumption of a communication base station.

### Solution to Problem

According to an aspect of embodiments of the disclosure, a method performed by a UE in a communication system may be provided.

According to an embodiment of the disclosure, the method may include determining at least two kinds of periods of a signal.

According to an embodiment of the disclosure, the method may include receiving or transmitting the signal based on the at least two kinds of periods.

According to an embodiment of the disclosure, receiving or transmitting the signal based on the at least two kinds of periods may include at least one of the following ways: receiving or transmitting the signal based on a second period during a first duration within each cycle or some cycle of first period corresponding to the signal; receiving or transmitting the signal based on alternately the first period and the second period; or in a case of receiving or transmitting the signal based on the first period, based on an indication of medium access control (MAC) control element (CE) and/or downlink control information (DCI), receiving or transmitting the signal based on the second period during a second duration, the first period being greater than the second period.

According to an embodiment of the disclosure, the alternately the first period and the second period may include alternately M successive first periods and N successive second periods, and both M and N are positive integers.

According to an aspect of the embodiments of the disclosure, a method performed by a UE in a communication system may be provided.

According to an embodiment of the disclosure, the method may include receiving indication information from a base station, where the indication information indicates that the signal is set as mute state at a specific occasion.

According to an embodiment of the disclosure, the method may include not receiving or transmitting the signal at the specific occasion based on the indication information.

According to an embodiment of the disclosure, the indication information may include at least one of the following: location information for indicating the specific occasion in which the signal is set as mute state, where the locations of the specific occasions are equally spaced; bitmap information for indicating whether the signal is respectively set as mute state at each occasion within the third duration; bitmap information for indicating whether the signal is respectively set as mute state at each occasion during K periods after the indication information, K is a positive integer; or information for indicating that the signal is set as mute state at the transmission occasion after the indication information.

According to an embodiment of the disclosure, the indication information may be indicated by radio resource control (RRC) signaling; and/or the indication information is indicated by medium access control (MAC) control element (CE) and/or downlink control information (DCI).

According to an embodiment of the disclosure, the indication information being indicated by DCI may include the indication information being indicated by multiple indication fields included in the DCI, the multiple indication fields respectively correspond to information for indicating being set as mute state for one of multiple signals.

According to an embodiment of the disclosure, receiving or transmitting the signal may include at least one of the following: receiving a synchronization signal block (SSB); receiving paging messages; receiving a first system information block (SIB1); receiving Type0 physical downlink control channel (PDCCH) common search space (CSS); receiving other system information (OSI); receiving Type0A PDCCH CSS; receiving channel state information reference signal (CSI-RS); receiving a positioning reference signal (PRS); receiving a semi-persistent scheduling physical downlink shared channel (SPS PDSCH); transmitting a physical random access channel (PRACH); transmitting a scheduling request (SR); transmitting a sounding reference signal (SRS); reporting channel state information (CSI); transmitting a pre-configured grant physical uplink shared channel (CG-PUSCH); and transmitting a physical uplink control channel (PUCCH).

According to an aspect of the embodiments of the disclosure, a method performed by a UE in a communication system may be provided

According to an embodiment of the disclosure, the method may include receiving discontinuous transmission (DTX) configuration information from a base station.

According to an embodiment of the disclosure, the method may include determining an Active time of DTX and/or a Non-active time of DTX of the base station based on the DTX configuration information.

According to an embodiment of the disclosure, the base station may transmit downlink signals during the Active time of DTX, and the base station may not transmit downlink signals during the Non-active time of DTX.

According to an embodiment of the disclosure, the DTX configuration information may include at least one of the following: DTX period, and a length of DTX duration within each DTX cycle.

According to an embodiment of the disclosure, the DTX configuration information may include at least one of the following: first DTX state switching information, where the first DTX state switching information is for indicating the base station to switch from the Active time of DTX to the Non-active time of DTX, and/or the first DTX state switching information is for indicating the base station to switch from the Active time of DTX to the Non-active time of DTX and keep a fifth duration for the Non-active time of DTX; second DTX state switching information, where the second DTX state switching information is for indicating the base station to switch from the Non-active time of DTX to the Active time of DTX, and/or the second DTX state switching information is for indicating the base station to switch from the Non-active time of DTX to the Active time of DTX and keep a sixth duration for the Active time of DTX.

According to an embodiment of the disclosure, the first DTX state switching information may be indicated by at least one of medium access control (MAC) control element (CE), downlink control information (DCI), and a physical layer signal sequence; and/or the second DTX state switching information may be indicated by the DCI and/or the physical layer signal sequence.

According to an embodiment of the disclosure, the method may include transmitting request information carried by the physical uplink control channel (PUCCH) and/or the physical layer signal sequence, the request information is for requesting the base station to switch from the Non-active time of DTX to the Active time of DTX, and/or the request information is for requesting the base station to switch from the Non-active time of DTX to the Active time of DTX and keep a seventh duration for the Active time of DTX.

According to an embodiment of the disclosure, operations performed by the UE in the RRC non-connected state during the Non-active time of DTX of the base station may include at least one of the following: not expecting to receive downlink broadcast signaling; not initiating a random access procedure; receiving downlink broadcast signaling based on a third period, where the third period is greater than a period in which the UE receives the downlink broadcast signaling during the Active time of DTX of the base station; determining an available physical random access channel (PRACH) transmission occasion based on a fourth period, where the fourth period is greater than a period in which the UE determines the available PRACH transmission occasion during the Active time of DTX of the base station.

According to an embodiment of the disclosure, operations performed by the UE in the RRC connected state during the Non-active time of DTX of the base station may include at least one of the following: not monitoring the physical downlink control channel (PDCCH); determining whether to monitor the PDCCH based on a network configuration; not monitoring the PDCCH in the UE-specific search space and type3 common search space; determining the search space where the PDCCH to be monitored is located based on the network configuration; stopping a running discontinuous reception (DRX) timer; not starting a DRX-onDurationTimer at the beginning of the DRX cycle; determining whether to start the DRX-onDurationTimer at the beginning of a specific DRX cycle based on a high layer signaling configuration and/or an indication of a wake-up signal; not receiving downlink broadcast signaling; determining whether to receive downlink broadcast signaling based on the network configuration; not initiating a random access procedure; determining whether to initiate the random access procedure based on the network configuration; receiving a downlink periodic signal based on a fifth period, where the fifth period is greater than a period in which the UE receives the downlink periodic signal during the Active time of DTX of the base station; and transmitting an uplink periodic signal based on a sixth period, where the sixth period is greater than a period in which the UE transmits the uplink periodic signal during the Active time of DTX of the base station.

According to an aspect of embodiments of the disclosure, a method performed by a base station in a communication system may be provided

According to an embodiment of the disclosure, the method may include transmitting or receiving a signal based on at least two kinds of periods.

According to an embodiment of the disclosure, the method may include setting the signal as mute state at a specific occasion, and not transmitting or receiving the signal at the specific occasion.

According to an embodiment of the disclosure, the method may include transmitting, by the base station, discontinuous transmission (DTX) configuration information to a user equipment (UE), where the DTX configuration information is used for the UE to determine a Active time of DTX and/or a Non-active time of DTX of the base station.

According to an aspect of the embodiments of the disclosure, a user equipment (UE) may be provided.

According to an embodiment of the disclosure, the UE may include a transceiver and a processor coupled to the transceiver and configured to perform steps of the method performed by the UE.

According to an aspect of the embodiments of the disclosure, a base station may be provided.

According to an embodiment of the disclosure, the base station may include a transceiver and a processor coupled to the transceiver and configured to perform steps of the method performed by the base station and provided by the disclosure.

According to an aspect of the embodiments of the disclosure, a computer-readable storage medium is provided, on which a computer program is stored, the computer program, when executed by a processor, performs the steps of the method performed by the UE and provided by the disclosure.

According to an aspect of the embodiments of the disclosure, a computer-readable storage medium is provided, on which a computer program is stored, the computer program, when executed by a processor, performs the steps of the method performed by the base station and provided by the disclosure.

According to an aspect of the embodiments of the disclosure, a computer program product is provided, which includes a computer program, the computer program, when executed by a processor, performs the steps of the method performed by the UE and provided by the disclosure.

According to an aspect of the embodiments of the disclosure, a computer program product is provided, which includes a computer program, the computer program, when executed by a processor, performs the steps of the method performed by the base stations and provided by the disclosure.

The communication method, user equipment, base station, and storage medium provided in the embodiments of the disclosure can reduce the proportion of periodic signals, thereby reducing power consumption of communication base stations.

### Advantageous Effects of Invention

The embodiments of the disclosure may provide a method and apparatus to reduce the power consumption of a communication base station.

### BRIEF DESCRIPTION OF DRAWINGS

In order to explain the technical solutions in the embodiments of the disclosure more clearly, the drawings used in the description of the embodiments of the disclosure will be briefly illustrated below.

FIG. 1 is a schematic diagram of an overall structure of a wireless network according to an embodiment of the disclosure;

FIG. 2a is a schematic diagram of a transmission path according to an embodiment of the disclosure;

FIG. 2b is a schematic diagram of a receiving path according to an embodiment of the disclosure;

FIG. 3a is a schematic structural diagram of a UE according to an embodiment of the disclosure;

FIG. 3b is a schematic structural diagram of a base station according to an embodiment of the disclosure;

FIG. 4 is a schematic flowchart of a method performed by a UE according to an embodiment of the disclosure;

FIG. 5 is a schematic diagram of a small period within a large period according to an embodiment of the disclosure;

FIG. 6 is a schematic diagram of large periods alternating with small period according to an embodiment of the disclosure;

FIG. 7 is a schematic diagram of a base station dynamic adjustment period according to an embodiment of the disclosure;

FIG. 8 is a schematic flowchart of another method performed by the UE according to an embodiment of the disclosure;

FIG. 9 is a schematic diagram of muted periods being equal intervals according to an embodiment of the disclosure;

FIG. 10 is a schematic diagram of the muted period indicated by a bitmap according to an embodiment of the disclosure;

FIG. 11 is a schematic diagram of dynamically indicating the muted period according to an embodiment of the disclosure;

FIG. 12 is a schematic diagram of dynamically indicating that a transmission occasion is muted according to an embodiment of the disclosure;

FIG. 13 is a schematic flowchart of another method performed by the UE according to an embodiment of the disclosure;

FIG. 14 is a schematic diagram of the DTX period according to an embodiment of the disclosure;

FIG. 15 is a schematic structural diagram of an electronic device according to an embodiment of the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

To make the objects, the technical solutions and the advantages of embodiments of the disclosure more apparent, the technical solutions of the embodiments of the disclosure will be described in detail hereinafter in conjunction with the drawings of the embodiments of the disclosure.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In wireless mobile communication systems, it is always an important research direction to save power for a terminal (UE). In fact, it is also very important to save power for networks. The power consumption of mobile communication base stations accounts for about 60-70% of the total power consumption of operators. How to reduce the power consumption of communication base stations is of great significance for communication operators to achieve the goal of energy conservation and emission reduction.

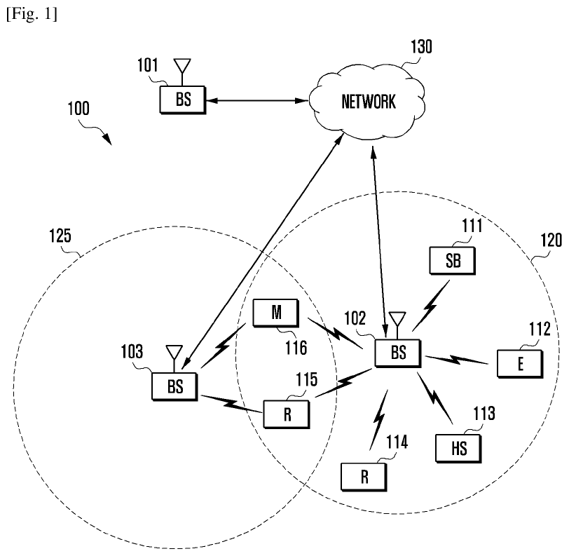

FIG. 1 illustrates an example wireless network 100 according to various embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

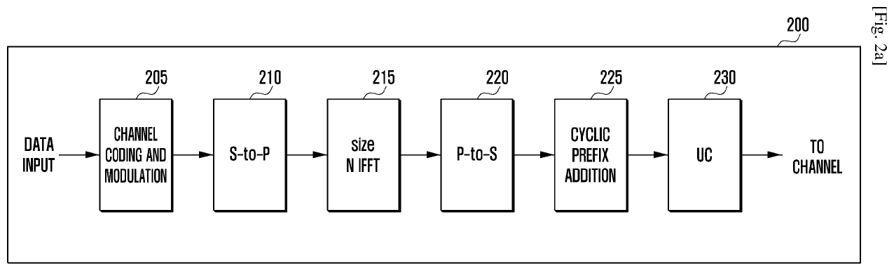

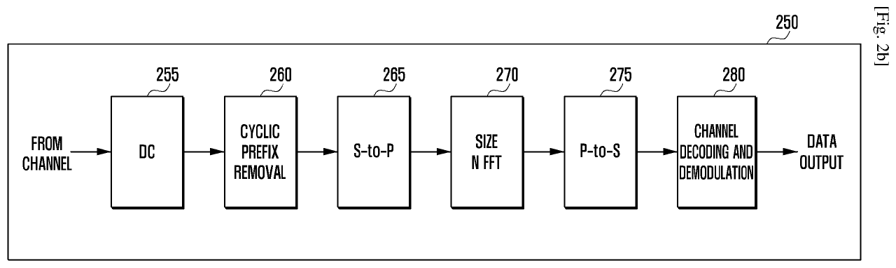

FIGS. 2a and 2b illustrate example wireless transmission and reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

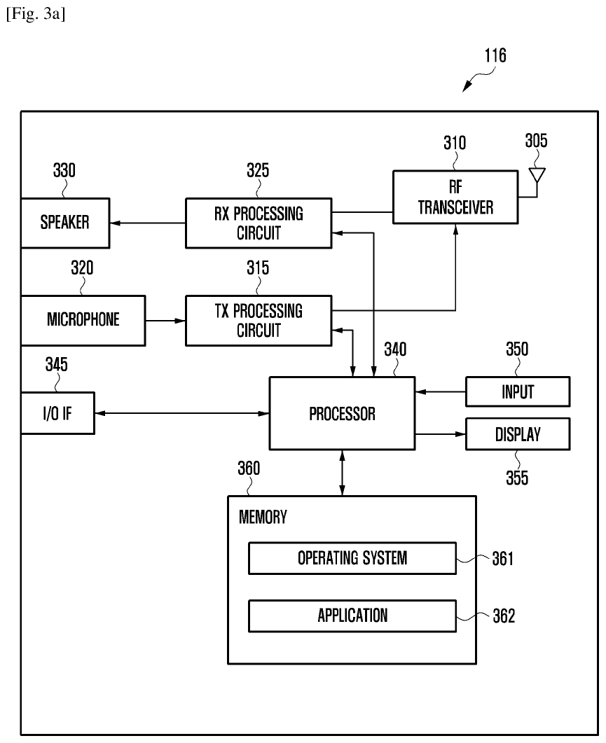

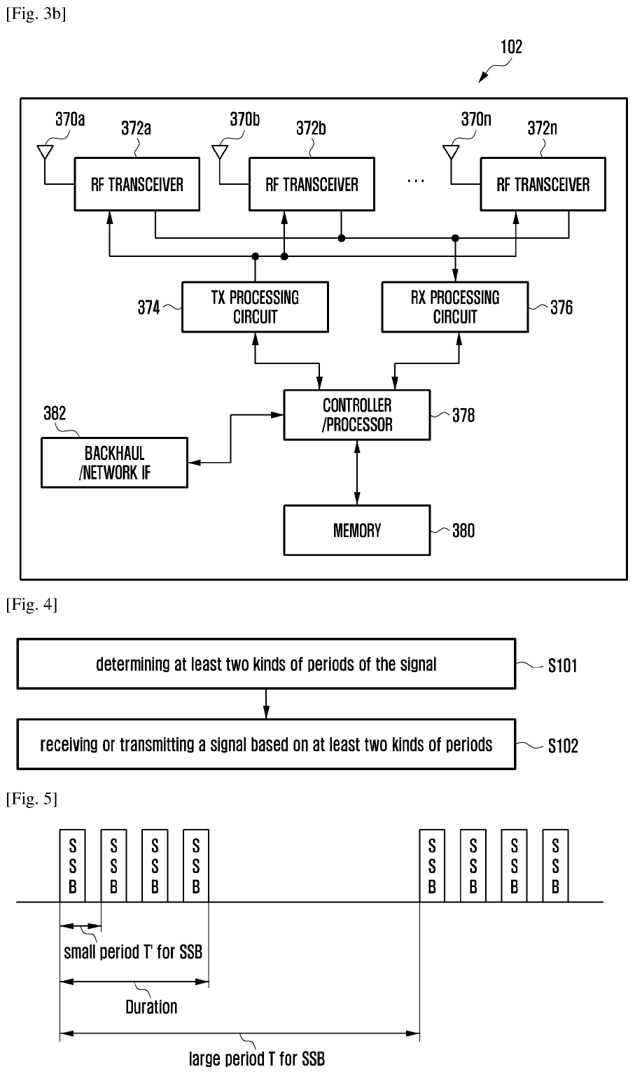

FIG. 3a illustrates an example UE 116 according to the disclosure. The embodiment of UE 116 shown in FIG. 3a is for illustration only, and UEs 111-115 of FIG. 1 can have the same or similar configuration. However, a UE has various configurations, and FIG. 3a does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the disclosure. The embodiment of gNB 102 shown in FIG. 3b is for illustration only, and other gNBs of FIG. 1 can have the same or similar configuration. However, a gNB has various configurations, and FIG. 3b does not limit the scope of the disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In a wireless communication system, the base station needs to periodically transmit downlink signals/channels, such as synchronization signal block (SSB), first system information block (SIB1), other system information (OSI), paging message, and other broadcast signaling, as well as channel status information reference signal (CSI-RS), positioning reference signal (PRS), semi-persistent scheduling PDSCH (SPS PDSCH) and other unicast signals/channels, the base station also needs to periodically monitor uplink signals/channels, such as physical random access channel (PRACH), scheduling request (SR), sounding reference signal (SRS), periodic channel status information (CSI) reporting, pre-configured grant physical uplink shared channel (CG-PUSCH), etc. The inventor of the disclosure has found that it can greatly reduce the power consumption of the base station by reducing the proportion of these periodic signals/channels. Based on that, an embodiment of the disclosure provides a method related to the power-saving technology of the base station from the perspective of reducing the proportion of periodic signals/channels.

The technical solutions of embodiments of the disclosure and the technical effects of the technical solutions of the disclosure will be described below by describing several exemplary embodiments. It should be noted that the following embodiments can be referred to, borrowed from, or combined with each other, and the same terms, similar features, and similar implementation steps in different embodiments will not be described repeatedly.

An embodiment of the disclosure provides a method performed by a UE in a communication system, as shown in FIG. 4, the method includes:

step S101: determining at least two kinds of periods of a signal;

step S102: receiving or transmitting the signal based on at least two kinds of periods.

Herein, a signal may refer to a signal in a communication system, or it may refer to any information transmitted as specified by two or more parties that need information in a communication system in a broad sense; for example, the signal may include a signal, a channel and so on, in a communication system. In other words, a signal in the disclosure may refer to a signal, or a channel, or may include both a signal and a channel. Similarly, a downlink signal may also refer to a downlink signal and/or channel, and an uplink signal may also refer to an uplink signal and/or channel. Hereinafter, for the convenience of description, a signal and/or a channel may also be referred to as a signal/channel, that is, “/” and “and/or” can be replaced with each other, that is, a signal/channel may also include a signal, may include a channel, or may include both a signal and a channel.

In embodiments of the disclosure, a larger period is introduced for periodic signals/channels to achieve the purpose of sparser periods, thereby reducing the proportion of periodic signals/channels, and realizing power-saving of the base station.

In view that it may affect the UE experience and data delay if the period of the signal/channel is too sparse, the period can be configured to appear in two types as dense and sparse in the time domain, that is, the periodic signal/channel has two kinds of periods.

Taking the signal/channel being SSB as an example, the SSB can be very sparse in some durations but very dense in other durations. This is different from the single-period SSB of the existing system. The sparse SSB is to reduce the proportion of SSB thereby reducing power consumption of the base station, while the dense SSB is to meet specific synchronization accuracy and/or measurement accuracy of the UE.

In embodiments of the disclosure, in order to realize the configuration of this feature, that is, based on two kinds of periods, receiving or transmitting signals/channels may include the following ways.

(1) The signal is received or transmitted based on a second period during a first duration of each or a part of a first period corresponding to the signal.

In embodiments of the disclosure, the two kinds of periods of the periodic signal/channel include a sparse large period (i.e., the first period) and a dense small period (i.e., the second period), that is, the first period is greater than the second period (the size (also referred to as length) of the first period is greater than the size of the second period). In each large period or a specific large period of a signal/channel, the signal/channel also occurs in a small period for a duration or a preset number of small period, which can be understood as a small period within a large period.

Continuing with the example that the signal/channel is SSB, the dense SSB occurs in a duration (i.e., the first duration) of each first period. Alternatively, the dense small period occurs only in a specific SSB first period, and it may additionally configure the occasion of the specific SSB first period including dense SSB transmission (that is, making transmission based on the second period within the first period) through signaling. For example, the base station may configure one SSB first period in every X SSB first periods which has the dense SSB being based on the second period.

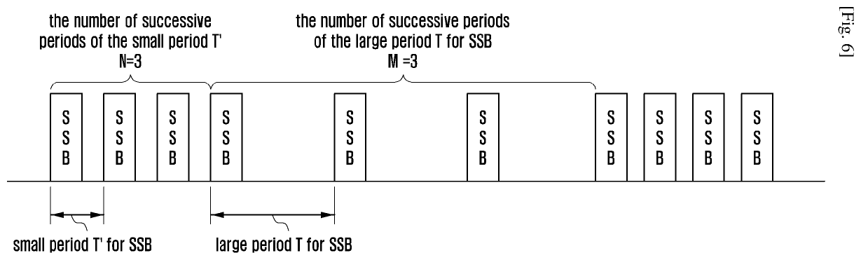

As shown in FIG. 5, the large period (first period) of SSB is T milliseconds, and in each (or specific) large period of SSB, SSBs occur intensively in a small period (second period) T′, and the transmission of SSB in small period T′ can be kept a duration (that is, the first duration), or kept K periods of SSB.

In embodiments of the disclosure, at least one of the size of the first period, the size of the second period, the occasion of the transmission based on the second period in the first period, and the length of the first duration may be configured by the base station, for example, through radio resource control (RRC) signaling (that is, at least one of the parameters T, T′, Duration, and K is configured through RRC signaling), and/or at least one of the size of the first period, the size of the second period, the occasion of the transmission based on the second period in the first period, and the length of the first duration may also be dynamically configured, but not limited thereto.

(2) The signal/channel is received or transmitted based on alternated first period and second period.

In embodiments of the disclosure, the two kinds of periods of the periodic signal/channel include a sparse large period (that is, the first period) and a dense small period (that is, the second period), that is, the first period is greater than the second period, and the two kinds of periods alternately occur, that is, the signal/channel occurs in a large period for a duration or a preset number of large periods, then occurs in a small period for another duration or another preset number of small period, which is repeated periodically. The first period and/or the second period may be configured through high layer signaling, for example, configured through RRC signaling, and/or dynamically configured, but not limited thereto.

In embodiments of the disclosure, the alternated first period and second period include M successive first periods and N successive second periods being alternately occurred, M and N are both positive integers, and M is predefined or configured by the base station, for example, configured through RRC signaling, and/or dynamically configured; N is predefined or configured by the base station, for example, configured through RRC signaling, and/or dynamically configured, but not limited thereto.

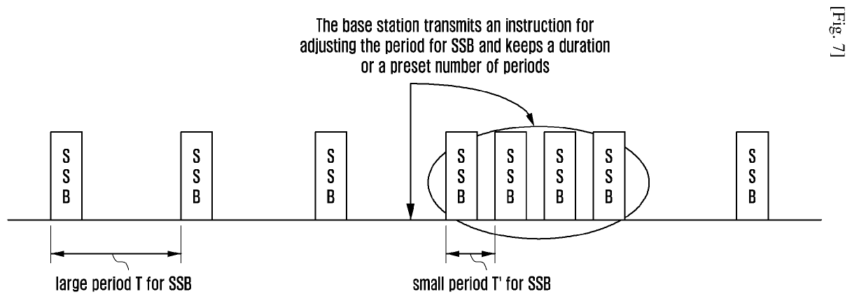

Continuing with the example that the signal/channel is SSB, SSB occurs alternately in the sparse period (the first period) and the dense period (the second period), as shown in FIG. 6, the large period (the first period) of SSB is T milliseconds, and the small period (the second period) is T′ milliseconds. After the SSB occurs in a large period for M large periods, the SSB occurs in a small period for N small period, and then the SSB occurs in the two kinds of periods alternately, where the parameters T, T′, M, and N are configured by the base station, for example, parameters T, T′, M, and N are configured through RRC signaling, but not limited thereto.

(3) In a case of receiving or transmitting the signal based on the first period, according to an indication of medium access control (MAC) control element (CE) and/or downlink control information (DCI), the signal is received or transmitted based on the second period during a second duration.

That is, in embodiments of the disclosure, the base station adjusts the period of the signal/channel through dynamic signaling, for example, the base station adjusts the period of the signal/channel through MAC CE and/or DCI, for example, the base station adjusts the period of the SSB through a newly defined common DCI, and it can also be common DCI, but not limited thereto.

The first period (e.g. the size of the first period) is configured through RRC signaling, the second period (e.g. the size of the first period) is configured through RRC signaling and/or indicated by MAC CE and/or DCI, and the length of the second duration is configured through RRC signaling and/or indicated through MAC CE and/or DCI.

Continuing with the example that the signal/channel is SSB, the period of SSB indicated by SIB1 is a large period. For UE in RRC connected state, the base station can dynamically adjust the period of SSB based on whether the UE has measurement requirements, and the base station can indicate SSB to occur in small period for a duration or a preset number of periods through MAC CE and/or DCI, as shown in FIG. 7.

In order to avoid impact on the legacy UEs (old version UEs) of the system, the sparse period (the large period) can be defaulted to the period of SSB indicated in SIB1, that is, the legacy UE can only receive the SSB of the large period, and only the new UE (new release UE) can receive the new SSB configuration parameters; or the SSB of the dynamic signaling adjustment period is the non-cell defining SSB (NCD-SSB), that is, the legacy UE can only receive the cell defining SSB (CD-SSB), the new release UE can receive NCD-SSB with new configuration parameters.

In embodiments of the disclosure, the receiving or transmitting the signal/channel includes at least one of the following: receiving a synchronization signal block (SSB); receiving paging messages; receiving a first system information block (SIB1); receiving Type0 physical downlink control channel (PDCCH) common search space (CSS); receiving other system information (OSI); receiving Type0A PDCCH CSS; receiving channel state information reference signal (CSI-RS); receiving a positioning reference signal (PRS); receiving a semi-persistent scheduling physical downlink shared channel (SPS PDSCH); transmitting a physical random access channel (PRACH); transmitting a scheduling request (SR); transmitting a sounding reference signal (SRS); reporting channel state information (CSI); transmitting a pre-configured grant physical uplink shared channel (CG-PUSCH), and so on.

In other words, the above-mentioned method using SSB as an example is also applicable to other periodic signals/channels, such as paging occasion (PO), SIB1, OSI, CSI-RS, SPS-PDSCH, PRACH, SR, CG-PUSCH, SRS, CSI reporting, etc., where the period of PO can be adjusted by adjusting the DRX period in idle state, the period of SIB1 can be adjusted by adjusting the period of Type0 PDCCH CSS, the period of OSI can be adjusted by adjusting the period of Type0A PDCCH CSS, and the period of SR and CSI reporting can be adjusted by adjusting the period of physical uplink control channel (PUCCH).

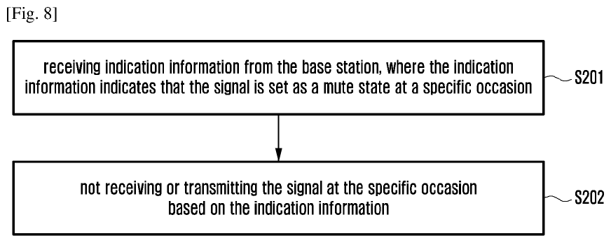

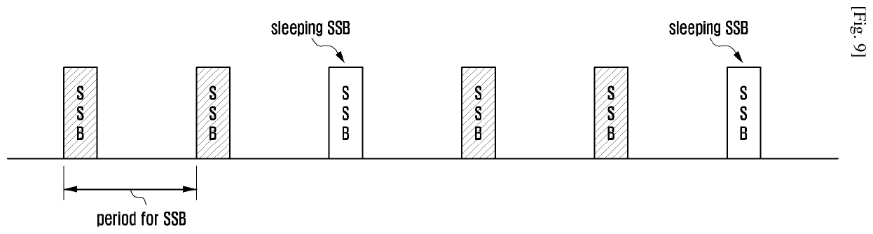

An embodiment of the disclosure provides a method performed by a UE in a communication system. As shown in FIG. 8, the method includes:

step S201: receiving indication information from the base station, where the indication information indicates that the signal is set as mute state at a specific occasion; and

step S202: not receiving or transmitting the signal at the specific occasion based on the indication information.

In embodiments of the disclosure, the base station may indicate that a periodic signal or a periodic channel is muted at some occasion, that is, the base station does not transmit or receive this signal/channel during these muted periods, and the UE does not expect to receive or transmit this signal/channel during these muted periods.

Taking an example that the signal/channel is SSB, the base station can indicate that the SSB is muted at some occasion, that is, the SSB is not actually transmitted by the base station. For example, the base station does not actually transmit the SSB at some occasion of the SSB since it enters a sleeping power-saving state. In order to prevent the UE from receiving the SSB that is not actually transmitted, the base station should indicate the occasion of the muted SSB.

In embodiments of the disclosure, the base station may semi-statically indicate the occasion of the muted signal/channel.

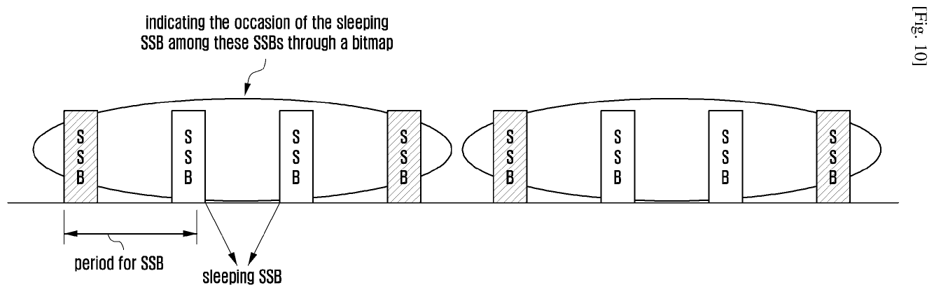

In an optional implementation, the period in which the periodic signal/channel is muted has a characteristic of equal intervals. Continuing with the example that the signal/channel is SSB, as shown in FIG. 9, the muted SSBs have the characteristic of equal intervals, for example, the base station indicates that one SSB is muted in every N successive SSBs, where N can be configured by the base station, the occasion of the muted SSB among the N SSBs can be determined according to a predefined rule, or indicated by the base station. For example, the above indication information may include location information for indicating the specific occasion in which a signal/channel is set as mute state, and the locations of the specific occasions are equally spaced, and the location information may be indicated by RRC signaling, but not limited thereto.

In another optional implementation, the base station may indicate the location of a specific occasion in which the periodic signal/channel is muted within a duration or multiple successive periods through a bitmap, that is, the above indication information may include bitmap information for indicating whether the signal/channel is set as mute state within respective periods of the third duration (or within K periods after the indication information). The indication information may be indicated by RRC signaling, but not limited thereto. The length of the third duration may be predefined or configured by the base station, but not limited thereto. The third duration is repeatable, that is, the indication information of the bitmap is repeatable. Continuing with the example that the signal/channel is SSB, for example, as shown in FIG. 10, the base station indicates the occasion of the SSB that is not actually transmitted by the base station within 100 milliseconds or multiple successive periods, and each bit in the bitmap corresponds to 100 milliseconds or an SSB transmission occasion in successive multiple periods, the bit indication value “0” indicates that the corresponding SSB is not actually transmitted by the base station, and the bit indication value “1” indicates that the corresponding SSB is actually transmitted by the base station. In addition, the bitmap is repeatable, for example the bitmap is repeated once time every 100 milliseconds.

In embodiments of the disclosure, the base station may also dynamically indicate the occasion of the muted signal/channel.

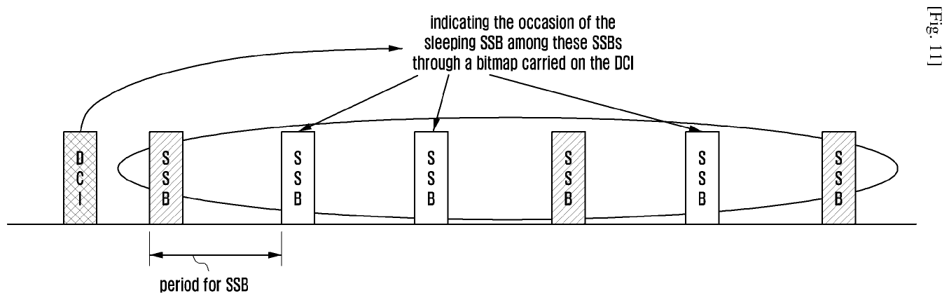

In an optional implementation, the base station may dynamically indicate that some periods of the periodic signal/channel are muted through a bitmap, that is, the above indication information includes bitmap information for indicating whether the signal/channel is set as mute state within respective periods of K periods after the indication information (or within the third duration). The indication information is indicated by MAC CE and/or DCI, K is a positive integer, and K is predefined or configured by the base station. Continuing with the example that the signal/channel is SSB, the base station indicates the occasion of the muted SSB in the next duration or multiple successive periods through MAC CE and/or DCI, for example, indicates whether each SSB is muted in a next duration or multiple successive periods through a bitmap in the common DCI, as shown in FIG. 11, that is, each bit in the bitmap corresponds to an SSB transmission occasion, and the bit indication value “0” indicates that the SSB is not actually transmitted by the base station, the bit indication value “1” indicates that the SSB is actually transmitted by the base station.

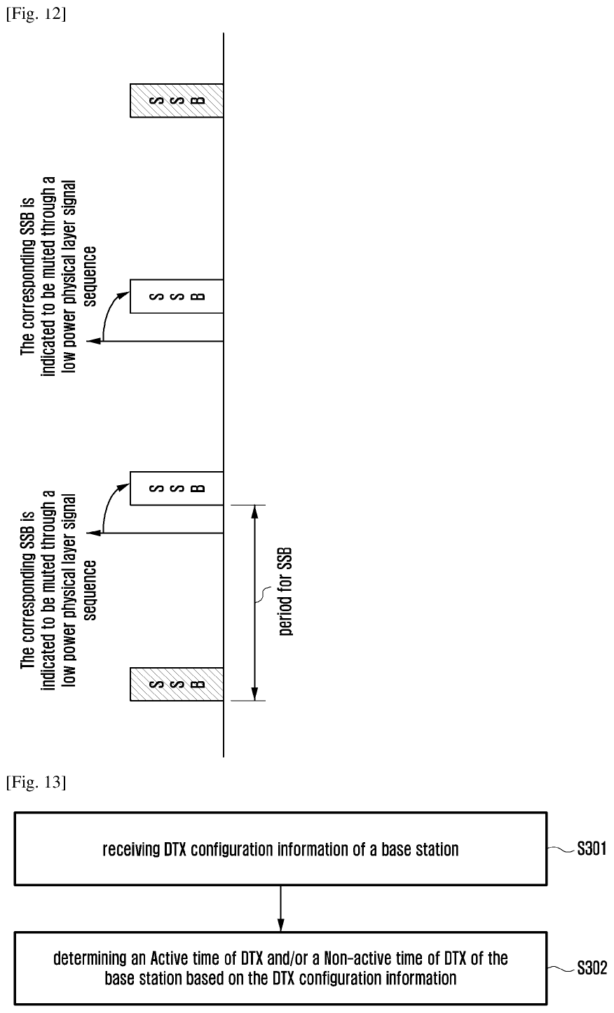

In another optional implementation, the base station indicates that the transmission occasion after the indication information is muted through at least one of MAC CE, DCI, or physical layer signal sequence before some periods of the periodic signal/channel, that is, the above indication information includes information for indicating that the transmission occasion of the signal/channel after the indication information is set as mute state, and the information is indicated by at least one of MAC CE, DCI, and physical layer signal sequence. Continuing with the example that the signal/channel is SSB, if the base station cannot actually transmit the SSB, then the base station needs to transmit the MAC CE, DCI and/or physical layer signal sequence to inform the UE in advance, as shown in FIG. 12, so that the UE does not expect to receive the corresponding SSB.

In another optional implementation, the base station indicates that multiple periodic signals/channels are muted at some occasion through DCI, and the DCI includes multiple independent indication fields, and different indication fields indicate that different periodic signals/channels are muted in a specific occasion. Optionally, the above indication information includes bitmap information for indicating whether the signal/channel is set as mute state within respective periods of K periods after the indication information (or within the third duration), and the bitmap information may be indicated by multiple indication fields included in the DCI, the multiple indication fields respectively correspond to information for one of multiple signals for indicating whether respective periods within K periods after the indication information (or within the third duration) are set as mute state. Alternatively, the above indication information includes information for indicating that the transmission occasion of the signal/channel after the indication information is set as mute state, and the information may be indicated by multiple indication fields included in the DCI, and the multiple indication fields respectively correspond to information for one of multiple signals for indicating whether the transmission occasion after the indication information is set as mute state. For example, one indication field may indicate in the form of a bitmap whether the SSB in the next duration is muted at each transmission occasion, and the other indication field may indicate in the form of a bitmap whether the PRACH in the next duration is muted at each transmission occasion; or one indication field indicates with 1 bit whether the next SSB is muted, and the other indicates with 1 bit whether the next PRACH is muted.

The above DCI used to indicate that common signaling such as SSB and PRACH is muted in some transmissions can be carried by a group common (GC) PDCCH. For example, a new DCI format is defined for carrying such signaling, the indication fields included in the DCI format and the number of bits included in each indication field are configurable, and the radio network tempory identity (RNTI) value used by the UE to monitor the DCI format may be a predefined RNTI value with a fixed size, or the RNTI value configured through system information, or the RNTI value configured through UE-specific RRC signaling. For the method of configuring the RNTI value through UE-specific RRC signaling, the base station may configure all UEs or a group of UEs monitor the same PDCCH to achieve the purpose of saving signaling overhead.

In embodiments of the disclosure, the receiving or transmitting the signal/channel includes at least one of the following: receiving SSB; receiving paging messages; receiving SIB1; receiving Type0 PDCCH CSS; receiving OSI; receiving Type0A PDCCH CSS; receiving CSI-RS; receiving PRS; receiving SPS PDSCH; transmitting PRACH; transmitting SR; transmitting SRS; reporting CSI; transmitting CG-PUSCH, and so on.

In other words, the above-mentioned method using SSB as an example is also applicable to other periodic signals/channels, such as PO, SIB1, OSI, CSI-RS, SPS-PDSCH, PRACH, SR, CG-PUSCH, SRS, CSI reporting, etc., where for SIB1, it can be realized by indicating that the Type0 PDCCH CSS is muted at some occasion; for OSI, it can be realized by indicating that the Type0A PDCCH CSS is muted at some occasion; for SR and CSI reporting, it can be realized by indicating that periodic PUCCH is muted at some occasion.

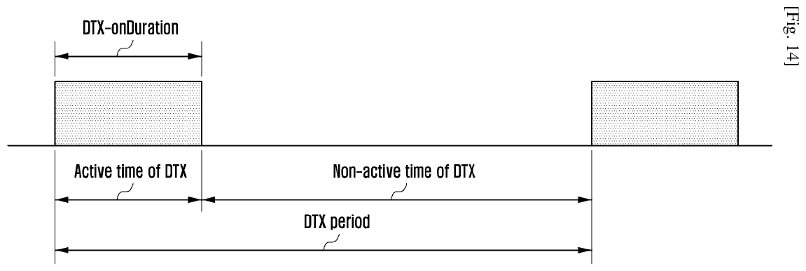

An embodiment of the disclosure provides a method performed by a UE in a communication system, as shown in FIG. 13. The method includes:

step S301: receiving discontinuous transmission (DTX) configuration information from a base station;

step S302: determining an Active time of DTX and/or a Non-active time of DTX of the base station based on the DTX configuration information.

The base station may transmit downlink signals during the Active time of DTX, and the base station does not transmit downlink signals during the Non-active time of DTX.

In embodiments of the disclosure, the base station may use discontinuous transmission technology to achieve the purpose of power saving, that is, the base station stops transmitting any signal/channel within a duration to achieve the purpose of power saving.

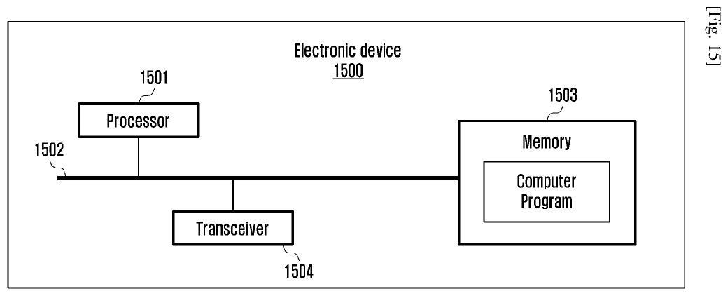

As shown in FIG. 14, the DTX configuration information includes at least parameters, such as DTX period and/or the length of DTX duration in each DTX cycle (DTX-onDuration). Each DTX cycle includes an Active time of DTX and/or a Non-active time of DTX. The duration of DTX-onDuration is referred to as Active time of DTX, Active time of DTX may also be referred to as ON state, active state, non-sleeping state, non-power-saving state, non-sleeping power-saving state, etc., and the time outside DTX-onDuration is referred to as the Non-active time of DTX. The Non-active time of DTX may also be referred to as OFF state, inactive state, sleeping state, power-saving state, sleeping power-saving state, etc. The base station may normally transmit downlink signals/channels during the Active time of DTX, and does not transmit downlink signals/channels during the Non-active time of DTX, or only transmits some specific downlink signals/channels during the Non-active time of DTX.

In embodiments of the application, the ON state and/or OFF state of the base station may be configured through semi-static signaling, for example, the DTX of the base station may be configured through a system message, or configured through UE-specific RRC signaling, but not limited thereto.

In this embodiment of the disclosure, the base station may also be instructed to switch between the ON state and the OFF state through dynamic signaling.

Optionally, the UE receives first DTX state switching information (also referred to as a power-saving state switching instruction) indicated by at least one of MAC CE, DCI, and physical layer signal sequence, and the first DTX state switching information is for indicating the base station to switch from the Active time of DTX to the Non-active time of DTX. For example, the base station is instructed to switch from the ON state to the OFF state through MAC CE or DCI; and/or the first DTX state switching information is for indicating the base station to switch from the Active time of DTX to the Non-active time of DTX, and keep a fifth duration for the Non-active time of DTX. For example, the base station is instructed to switch from the ON state to the OFF state through MAC CE or DCI and keep a duration (fifth duration). After this duration, the UE may assume that the base station returns to the ON state from the OFF state. The length of the fifth duration (that is, the duration of the OFF state) is predefined, configured through RRC signaling, and/or indicated through MAC CE and/or DCI.

In practical applications, the DCI carrying the DTX state switching information of the base station may be the common DCI of the cell, that is, it can be received by a group of UEs or all UEs. For example, UEs in the RRC connected state and UEs in the RRC non-connected state need to monitor the common DCI of the cell, or only the UEs in the RRC connected state need to monitor the common DCI of the cell.

Optionally, the UE receives second DTX state switching information indicated through DCI or a physical layer signal sequence, and the second DTX state switching information is for indicating the base station to switch from the Non-active time of DTX to the Active time of DTX; for example, the base station may be instructed to switch from the OFF state to the ON state through DCI and/or the physical layer signal sequence, and/or the second DTX state switching information is for indicating the base station to switch from the Non-active time of DTX to the Active time of DTX and keep a sixth duration for the Active time of DTX, for example, the base station may be instructed to switch from the OFF state to the ON state through the DCI and keep a duration (the sixth duration), and after this duration, the UE may assume that the base station returns to the OFF state from the ON state. The length of the sixth duration (that is, the duration of the ON state) is predefined, configured by the base station through RRC signaling, and/or indicated through DCI. This indicates that the base station under the OFF state may transmit an instruction indicating the base station to switch from the OFF state to the ON state, and the UE needs to periodically monitor, under the OFF state of the base station, the instruction indicating the base station to switch from the OFF state to the ON state.

Alternatively, the UE can also transmit request information carried by the PUCCH and/or physical layer signal sequence to the base station. The request information is for requesting the base station to switch from the Non-active time of DTX to the Active time of DTX, that is, the UE may request the base station to switch from the OFF state to the ON state; and/or the request information is for requesting the base station to switch from the Non-active time of DTX to the Active time of DTX and keep a seventh duration for the Active time of DTX, that is, the UE may request the base station to switch from the OFF state to the ON state and keep a duration (the seventh duration), after this duration, the base station may return from the ON state to the OFF state. The length of the seventh duration (that is, the duration of the ON state) is predefined, configured by the base station through RRC signaling, and/or indicated by the PUCCH and/or physical layer signal sequence.

In embodiments of the disclosure, the UE has different behaviors under the ON state and OFF state of the base station. For the switch between the ON and OFF states of DTX of the base station, it can be configured through semi-static signaling or dynamically instructed by the base station, the corresponding behavior of the UE under the ON state of the base station may be the same or different, and the corresponding behavior of the UE under the OFF state of the base station may be the same or different.

Alternatively, in embodiments of the application, the UEs in the RRC non-connected state (including UEs in the RRC idle state and/or UEs in the RRC inactive state) may have at least one of the following UE behaviors during the Non-active time of DTX of the base station:
(1) during the Non-active time of DTX of the base station, the UE does not expect to receive downlink broadcast signaling, for example, the UE does not expect to receive at least one of SSB, PO, SIB1, and OSI;
(2) during the Non-active time of DTX of the base station, the UE does not initiate a random access procedure, that is, does not transmit PRACH;
(3) during the Non-active time of DTX of the base station, the UE receives downlink broadcast signaling based on a third period, where the third period (the size of the third period) is greater than a period for the UE receiving the downlink broadcast signaling during the Active time of DTX of the base station, that is, the UE receives the downlink broadcast signaling based on relatively sparse period, such as at least one of SSB, PO, SIB1, and OSI, that is, the transmission of the downlink broadcast signaling in the Non-active time of DTX is sparser than that in the Active time of DTX; it can be understood that different downlink broadcast signaling may correspond to the same or different third periods, and the third period for which any downlink broadcast signaling is received is greater than a period for the UE receiving the downlink broadcast signaling during the Active time of DTX of the base station;
(4) during the Non-active time of DTX of the base station, the UE determines the available PRACH transmission occasions based on a fourth period, where the fourth period (the size of the fourth period) is greater than a period for which the UE determining the available PRACH transmission occasions during the Active time of DTX of the base station, that is, the UE determines available PRACH transmission occasions based on relatively sparse period, that is, the transmission of the PRACH in the Non-active time of DTX is sparser than that in the Active time of DTX.

Correspondingly, UEs in RRC non-connected state (including UEs in RRC idle state and/or UEs in RRC inactive state) may have at least one of the following UE behaviors during the Active time of DTX of the base station:
(1) during the Active time of DTX of the base station, the UE can receive downlink broadcast signaling, for example normally receive at least one of SSB, PO, SIB1, and OSI;
(2) during the Active time of DTX of the base station, the UE can initiate a random access procedure, that is, the UE can transmit PRACH; the last available RO during the Active time of DTX is the nearest RO that meets the preset interval before the end of the Active time of DTX; the preset interval shall include all time required to complete a successful random access procedure;
(3) during the Active time of DTX of the base station, the UE receives downlink broadcast signaling based on a relatively dense period, such as at least one of SSB, PO, SIB1, and OSI, that is, the transmission of downlink broadcast signaling in the Active time of DTX is denser than that in Non-active time of DTX;
(4) during the Active time of DTX of the base station, the UE determines the available PRACH transmission occasions based on relatively dense period, that is, the PRACH transmission in the Active time of DTX of the base station is denser than that in the Non-active time of DTX.

In embodiments of the disclosure, the UEs in the RRC connected state may have at least one of the following UE behaviors during the Non-active time of DTX of the base station:
(1) during the Non-active time of DTX of the base station, the UE does not monitor the PDCCH, including the PDCCH in any search space;
(2) during the Non-active time of DTX of the base station, the UE determines whether to monitor the PDCCH according to the network configuration, that is, whether the UE monitors the PDCCH may be configured by the network, for example, whether to monitor the PDCCH is configured through high layer signaling configuration;
(3) during the Non-active time of DTX of the base station, the UE does not monitor the PDCCH in the UE-specific search space (USS) and the PDCCH in the Type3 CSS, and but needs to monitor the PDCCH on other search spaces;
(4) during the Non-active time of DTX of the base station, the UE determines the search space where the PDCCH to be monitored is located according to the network configuration, and the PDCCH in other search spaces does not need to be monitored; for example, the search space where the PDCCH to be monitored is configured through high layer signaling;
(5) during the Non-active time of DTX of the base station, the UE stops the running discontinuous reception (DRX) timer, for example, stops all running DRX timers, in other words, the UE stops monitoring the PDCCH;
(6) during the Non-active time of DTX of the base station, the UE does not start the DRX-onDurationTimer at the beginning of the DRX cycle, for example, the UE does not start the DRX-onDurationTimer at the beginning of each DRX cycle;
(7) during the Non-active time of DTX of the base station, the UE determines whether to start the DRX-onDurationTimer at the beginning of a specific DRX cycle according to the high layer signaling configuration and/or the indication of the wake-up signal, that is, whether the UE starts the DRX-onDurationTimer may be configured by high layer signaling and/or indicated by the wake-up signal;
(8) during the Non-active time of DTX of the base station, the UE does not receive downlink broadcast signaling, such as at least one of SSB, PO, SIB1, and OSI;
(9) during the Non-active time of DTX of the base station, the UE determines whether to receive downlink broadcast signaling according to the network configuration, such as at least one of SSB, PO, SIB1, and OSI, that is, whether the UE receives downlink broadcast signaling may be configured by the network, for example, whether to receive downlink broadcast signaling may be configured through high layer signaling;
(10) during the Non-active time of DTX of the base station, the UE does not initiate a random access procedure, that is, the UE does not transmit PRACH, except for the PRACH triggered by the PDCCH order;
(11) during the Non-active time of DTX of the base station, the UE determines whether it can transmit PRACH to initiate the random access procedure according to the network configuration, that is, whether it can initiate the random access procedure may be configured by the network, for example, whether it can transmit PRACH may be configured through high layer signaling configuration;
(12) during the Non-active time of DTX of the base station, the UE receives the downlink periodic signal based on a fifth period, where the fifth period (the size of the fifth period) is greater than a period for the UE receiving the downlink periodic signal during the Active time of DTX of the base station, that is, the UE receives the downlink periodic signals/channels based on relatively sparse period, including broadcast signals/channels, and/or unicast signals/channels, for example, including at least one of SSB, CSI-RS, PRS, PDCCH, and SPS-PDSCH, that is, the transmissions of these downlink periodic signals/channels in the Non-active time of DTX than are sparser than that in the Active time of DTX; it can be understood that different downlink periodic signals may correspond to the same or different fifth periods, and the fifth period in which any downlink periodic signal is received is greater than the period in which the UE receives the downlink periodic signal during the Active time of DTX of the base station;
(13) during the Non-active time of DTX of the base station, the UE transmits an uplink periodic signal based on a sixth period, where the sixth period (the size of the sixth period) is greater than a period in which the UE transmits an uplink periodic signal during the Active time of DTX of the base station, that is, the UE transmits uplink periodic signals/channels based on relatively sparse period, including at least one of PRACH, SR, periodic CSI reporting, SRS, and CG-PUSCH, that is, the transmissions of these uplink periodic signals/channels in the Non-active time of DTX of the base station are sparser than that in the Active time of DTX; it can be understood that different uplink periodic signals may correspond to the same or different sixth periods, and the sixth period in which any uplink periodic signal is transmitted is greater than the period in which the UE transmits the uplink periodic signal during the Active time of DTX of the base station.

Correspondingly, the UEs in the RRC connected state may have at least one of the following UE behaviors during the Active time of DTX of the base station:
(1) during the Active time of DTX of the base station, the UE can normally receive downlink signals/channels and transmit uplink signals/channels, for example, which is totally same with the behavior of UEs in the existing system, but not limited thereto;
(2) during the Active time of DTX of the base station, the UE receives downlink periodic signals/channels based on relatively dense period, including broadcast signals/channels, and/or unicast signals/channels, such as at least one of SSB, CSI-RS, PRS, PDCCH, and SPS-PDSCH, that is, the transmissions of these downlink periodic signals/channels in the Active time of DTX are denser than that in the Non-active time of DTX;
(3) during the Active time of DTX of the base station, the UE transmits uplink periodic signals/channels based on relatively dense period, including at least one of PRACH, SR, periodic CSI reporting, SRS, and CG-PUSCH, that is, the transmissions of these uplink periodic signals/channels in the Active time of DTX of the base station are denser than that in the Non-active time of DTX.

The method provided in embodiments of the disclosure can reduce the proportion of periodic signals/channels, thereby reducing the power consumption of communication base stations.

The reduction of power consumption of the base station can reduce the heat generated by the devices, and the power consumption of the air conditioner will also be reduced accordingly, which can reduce the electricity bill of operators and reduce the cost of operators.

An embodiment of the disclosure also provides a method performed by a base station in a communication system. The method includes:

transmitting or receiving a signal based on at least two kinds of periods; and/or

setting the signal as mute state at a specific occasion, and not transmitting or receiving the signal at the specific occasion; and/or

transmitting, by the base station, discontinuous transmission (DTX) configuration information to a user equipment (UE), where the DTX configuration information is used for the UE to determine an Active time of DTX and/or a Non-active time of DTX of the base station.

Similarly, the methods in the embodiments of the disclosure correspond to the methods in the embodiments on the UE side. For detailed function descriptions and beneficial effects, it may refer to the corresponding methods shown in the above embodiments on the UE side, which are not repeated herein.

An embodiment of the disclosure provides a user equipment. The user equipment may include a determining module and a first processing module, wherein

the determining module is configured to determine at least two kinds of periods of a signal;

the first processing module is configured to receive or transmit the signals based on at least two kinds of periods.

Optionally, the first processing module is further configured to perform at least of the following:

receiving or transmitting the signal based on a second period during a first duration within each cycle or some cycle of first period corresponding to the signal;

receiving or transmitting the signal based on alternately the first period and the second period; or

in a case of receiving or transmitting the signal based on the first period, based on an indication of medium access control (MAC) control element (CE) and/or downlink control information (DCI), receiving or transmitting the signal based on the second period during a second duration,

wherein the first period is greater than the second period.

Optionally, the alternately the first period and the second period includes:

alternately M successive first periods and N successive second periods, and both M and N are positive integers.

An embodiment of the disclosure provides a user equipment. The user equipment may further include a first receiving module and a second processing module, wherein,

the first receiving module is configured to receive indication information from the base station, where the indication information indicates that the signal is set as mute state at a specific occasion;

the second processing module is configured to not receive or transmit the signal at the specific occasion based on the indication information.

Optionally, the indication information includes at least one of the following:

location information for indicating a location of the specific occasion in which the signal is set as mute state, where the locations of the specific occasion are equally spaced;

bitmap information for indicating whether the signal is respectively set as mute state at each occasion within the third duration;

bitmap information for indicating whether the signal is respectively set as mute state at each occasion during K periods after the indication information, K is a positive integer;

information for indicating that the signal is set as mute state at the transmission occasion after the indication information.

Optionally, the indication information is indicated by RRC signaling; and/or

the indication information is indicated by MAC CE and/or DCI.

Optionally, the indication information being indicated by DCI includes: the indication information being indicated by multiple indication fields included in the DCI, the multiple indication fields respectively correspond to information for indicating being set as mute state of various signals.

Optionally, the second processing module is further configured to perform at least one of the following: receiving SSB; receiving paging messages; receiving SIB1; receiving Type0 PDCCH CSS; receiving OSI; receiving Type0A PDCCH CSS; receiving CSI-RS; receiving PRS; receiving SPS PDSCH; transmitting PRACH; transmitting SR; transmitting SRS; reporting CSI; transmitting CG-PUSCH; and transmitting PUCCH.

An embodiment of the disclosure provides a user equipment. The user equipment may further include a second receiving module and a third processing module, wherein,

The second receiving module is configured to receive DTX configuration information from a base station;

the third processing module is configured to determine an Active time of DTX and/or a Non-active time of DTX of the base station based on the DTX configuration information.

The base station can transmit downlink signals during the Active time of DTX, and the base station does not transmit downlink signals during the Non-active time of DTX.

Optionally, the DTX configuration information includes at least one of the following:

DTX period, and a length of DTX duration within respective DTX periods.

Optionally, the second receiving module is further configured to perform at least one of the following:

receiving first DTX state switching information indicated by at least one of MAC CE, DCI, and physical layer signal sequence, the first DTX state switching information is for indicating the base station to switch from the Active time of DTX to the Non-active time of DTX, and/or the first DTX state switching information is for indicating the base station to switch from the Active time of DTX to the Non-active time of DTX and keep a fifth duration for the Non-active time of DTX;

receiving second DTX state switching information indicated by DCI or a physical layer signal sequence, the second DTX state switching information is for indicating the base station to switch from the Non-active time of DTX to the Active time of DTX, and/or the second DTX state switching information is for indicating the base station to switch from the Non-active time of DTX to the Active time of DTX and keep a sixth duration for the Active time of DTX.

Optionally, the user equipment may further include a transmitting module.

The transmitting module is configured to transmit request information carried by the physical uplink control channel (PUCCH) and/or the physical layer signal sequence, the request information is for requesting the base station to switch from the Non-active time of DTX to the Active time of DTX, and/or the request information is for requesting the base station to switch from the Non-active time of DTX to the Active time of DTX and keep a seventh duration for the Active time of DTX; the length of the seventh duration is predefined, configured by the base station through RRC signaling, or indicated by the PUCCH or physical layer signal sequence.

Optionally, the operations performed by the UE in the RRC non-connected state during the Non-active time of DTX of the base station comprise at least one of the following:

not expecting to receive downlink broadcast signaling;

not initiating a random access procedure;

receiving downlink broadcast signaling based on a third period, where the third period is greater than a period in which the UE receives the downlink broadcast signaling during the Active time of DTX of the base station;

determining an available physical random access channel (PRACH) transmission occasion based on a fourth period, where the fourth period is greater than a period in which the UE determines the available PRACH transmission occasion during the Active time of DTX of the base station.

Optionally, the operations performed by the UE in the RRC connected state during the Non-active time of DTX of the base station comprises at least one of the following:

not monitoring the physical downlink control channel (PDCCH);

determining whether to monitor the PDCCH based on a network configuration;

not monitoring the PDCCH in the UE-specific search space and type3 common search space;

determining the search space where the PDCCH to be monitored is located based on the network configuration;

stopping a running discontinuous reception (DRX) timer;

not starting a DRX-onDurationTimer at the beginning of the DRX cycle;

determining whether to start the DRX-onDurationTimer at the beginning of a specific DRX cycle based on a high layer signaling configuration and/or an indication of a wake-up signal;

not receiving downlink broadcast signaling;

determining whether to receive downlink broadcast signaling based on the network configuration;

not initiating a random access procedure;

determining whether to initiate the random access procedure based on the network configuration;

receiving a downlink periodic signal based on a fifth period, wherein the fifth period is greater than a period in which the UE receives the downlink periodic signal during the Active time of DTX of the base station; and

transmitting an uplink periodic signal based on a sixth period, wherein the sixth period is greater than a period in which the UE transmits the uplink periodic signal during the Active time of DTX of the base station.

An embodiment of the disclosure also provides a base station, which may include at least one of a processing module, a configuration module, and a transmitting module, wherein,

the processing module is configured to transmit or receive a signal based on at least two kinds of periods;

the configuration module is configured to set the signal as mute state at a specific occasion, and not transmit or receive the signal at the specific occasion;

the transmitting module is configured to transmit discontinuous transmission (DTX) configuration information to a user equipment (UE), where the DTX configuration information is used for the UE to determine an Active time of DTX and/or a Non-active time of DTX of the base station.

The user equipment and the base station in the embodiments of the disclosure can perform the methods provided by the embodiments of the disclosure, which have similar implementation principles. The actions performed by respective modules of the UE and the base station according to embodiments of the disclosure correspond to the steps in the method according to embodiments of the disclosure; for the detailed function description and the beneficial effect of respective modules of the UE and the base station, it may refer to the description of the corresponding method shown above, and would not be repeated herein.

An embodiment of the disclosure provides an electronic device, which includes: a transceiver configured to transmit and receive signals; and a processor coupled to the transceiver and configured to perform the steps of the aforementioned method embodiments. Optionally, the electronic device may be a UE, and the processor of the electronic device is configured to perform the steps of the methods performed by the UE provided in the foregoing method embodiments. Optionally, the electronic device may be a base station, and the processor of the electronic device is configured to perform the steps of the method performed by the base station provided in the foregoing method embodiments.

In an optional embodiment, an electronic device is provided, as shown in FIG. 15, wherein the electronic device 1500 shown in FIG. 15 includes a processor 1501 and a memory 1503. Wherein, the processor 1501 communicates with the memory 1503, e.g., via a bus 1502. Optionally, the electronic device 1500 may also include a transceiver 1504, which may be used for data interaction between this electronic device and other electronic devices, such as data transmission and/or data reception. It should be noted that the transceiver 1504 is not limited to one in practical applications, and the structure of the electronic device 1500 does not constitute a limitation of this application embodiment.

The processor 1501 may be a central processing unit (CPU), a general-purpose processor, a digital signal processor (DSP), an application specific integrated circuit (ASIC), and a field programmable gate array (FPGA), or other programmable logic devices, transistor logic device, hardware component, or any combination thereof. It is possible to implement or execute the various exemplary logical blocks, modules, and circuits described in combination with the disclosures of the disclosure. The processor 1501 may also be a combination of computing functions, such as a combination of one or more microprocessors, a combination of a DSP and a microprocessor, and so on.

The bus 1502 can include a path for delivering information among the above components. The bus 1502 may be a peripheral component interconnect (PCI) bus or an extended industry standard architecture (EISA) bus. The bus 1502 may be divided into an address bus, a data bus, a control bus, and so on. For ease of illustration, only one bold line is shown in FIG. 15, but does not indicate that there is only one bus or type of bus.

The memory 1503 may be a read-only memory (ROM) or other types of static storage devices that can store static information and instructions, a random access memory (RAM) or other types of storage devices that can store information and instructions. The memory 1503 may also be electrically erasable programmable read-only memory (EEPROM), compact disc read-only memory (CD-ROM), or other optical disk storage, optical disk storage (including compressed compact disc, laser disc, compact disc, digital versatile disc, blue-ray disc, etc.), magnetic disk storage medium or other magnetic storage devices, or any other medium capable of carrying or storing computer programs and capable of being accessed by a computer, but not limited to this.

The memory 1503 is used to store computer programs for executing embodiments of the disclosure and is controlled for execution by the processor 1501. The processor 1501 is used to execute the computer program stored in memory 1503 to implement the steps shown in the preceding method embodiment.

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the disclosure described herein can be implemented in an order other than that illustrated or described in the text.

It should be understood that while the flow diagrams of embodiments of the disclosure indicate the individual operational steps by arrows, the order in which these steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the disclosure are not limited thereto.

The above-mentioned description is merely an alternative embodiment for some implementation scenarios of the disclosure, and it should be noted that it would have been within the scope of protection of embodiments of the disclosure for those skilled in the art to adopt other similar implementation means based on the technical idea of the disclosure without departing from the technical concept of the solution of the disclosure.

1. A method performed by a user equipment (UE) in a communication system, the method comprising:
determining at least two kinds of periods of a signal; and
receiving or transmitting the signal based on the at least two kinds of periods.

2. The method according to claim 1, wherein receiving or transmitting the signal based on the at least two kinds of periods comprise at least one of the following ways:
receiving or transmitting the signal based on a second period during a first duration within each cycle or some cycle of first period corresponding to the signal;
receiving or transmitting the signal based on alternately the first period and the second period; or
in case of receiving or transmitting the signal based on the first period, based on at least one of an indication of medium access control (MAC) control element (CE) or downlink control information (DCI), receiving or transmitting the signal based on the second period during a second duration,
wherein the first period is greater than the second period, and
wherein the alternately the first period and the second period comprise: alternately M successive first periods and N successive second periods, and both M and N are positive integers.

3. The method of claim 1, further comprising:
receiving indication information from the base station, wherein the indication information indicates that the signal is set as mute state at a specific occasion; and
identifying not receiving or transmitting the signal at the specific occasion based on the indication information.

4. The method according to claim 3, wherein the indication information comprises at least one of the following:
location information for indicating the specific occasion in which the signal is set as mute state, wherein the locations of the specific occasions are equally spaced;
bitmap information for indicating whether the signal is respectively set as mute state at each occasion within the third duration;
bitmap information for indicating whether the signal is respectively set as mute state at each occasion during K periods after the indication information, K is a positive integer; or
information for indicating that the signal is set as mute state at the transmission occasion after the indication information, and
wherein the indication information is indicated by at least one of the following:
radio resource control (RRC) signaling; or
at least one of medium access control (MAC) control element (CE) or downlink control information (DCI).

5. The method according to claim 4, wherein the indication information being indicated by DCI comprises:
the indication information being indicated by multiple indication fields included in the DCI, the multiple indication fields respectively correspond to information for indicating being set as mute state for one of multiple signals.

6. The method according to claim 1, wherein the receiving or transmitting the signal comprises at least one of the following:
receiving a synchronization signal block (SSB);
receiving paging messages;
receiving a first system information block (SIB1);
receiving Type0 physical downlink control channel (PDCCH) common search space (CSS);
receiving other system information (OSI);
receiving Type0A PDCCH CSS;
receiving channel state information reference signal (CSI-RS);
receiving a positioning reference signal (PRS);
receiving a semi-persistent scheduling physical downlink shared channel (SPS PDSCH);
transmitting a physical random access channel (PRACH);
transmitting a scheduling request (SR);
transmitting a sounding reference signal (SRS);
reporting channel state information (CSI);
transmitting a pre-configured grant physical uplink shared channel (CG-PUSCH); and
transmitting a physical uplink control channel (PUCCH).

7. The method of claim 1, further comprising:
receiving discontinuous transmission (DTX) configuration information of a base station;
determining, based on the DTX configuration information, at least one of an active time of DTX or a non-active time of DTX of the base station.

8. The method according to claim 7, wherein the DTX configuration information comprises at least one of the following: DTX period, and a length of DTX duration within each DTX cycle.

9. The method according to claim 7, wherein the DTX configuration information comprises at least one of the following:
first DTX state switching information, wherein the first DTX state switching information is for at least one of indicating the base station to switch from the active time of DTX to the non-active time of DTX, or indicating the base station to switch from the active time of DTX to the non-active time of DTX and keep a fifth duration for the Non-active time of DTX; or
second DTX state switching information, wherein the second DTX state switching information is for at least one of indicating the base station to switch from the non-active time of DTX to the active time of DTX, or indicating the base station to switch from the non-active time of DTX to the active time of DTX and
keep a sixth duration for the active time of DTX, and wherein at least one of the following is satisfied:
the first DTX state switching information is indicated by at least one of medium access control (MAC) control element (CE), downlink control information (DCI), and a physical layer signal sequence; or
the second DTX state switching information is indicated by at least one of the DCI or the physical layer signal sequence.

10. The method of claim 7, further comprising:
transmitting request information carried by at least one of the physical uplink control channel (PUCCH) or the physical layer signal sequence, wherein the request information is for at least one of requesting the base station to switch from the non-active time of DTX to the active time of DTX, or requesting the base station to switch from the non-active time of DTX to the active time of DTX and keep a seventh duration for the active time of DTX.

11. The method according to claim 7, wherein operations performed by the UE in the RRC non-connected state during the non-active time of DTX of the base station comprise at least one of the following:
not expecting to receive downlink broadcast signaling;
not initiating a random access procedure;
receiving downlink broadcast signaling based on a third period, wherein the third period is greater than a period in which the UE receives the downlink broadcast signaling during the active time of DTX of the base station;
determining an available physical random access channel (PRACH) transmission occasion based on a fourth period, wherein the fourth period is greater than a period in which the UE determines the available PRACH transmission occasion during the active time of DTX of the base station.

12. The method according to claim 7, wherein operations performed by the UE in the RRC connected state during the non-active time of DTX of the base station comprises at least one of the following:
not monitoring the physical downlink control channel (PDCCH);
determining whether to monitor the PDCCH based on a network configuration;
not monitoring the PDCCH in the UE-specific search space and type3 common search space;
determining the search space where the PDCCH to be monitored is located based on the network configuration;
stopping a running discontinuous reception (DRX) timer;
not starting a DRX-onDurationTimer at the beginning of the DRX cycle;
determining whether to start the DRX-onDuration Timer at the beginning of a specific DRX cycle based on at least one of a high layer signaling configuration or an indication of a wake-up signal;
not receiving downlink broadcast signaling;
determining whether to receive downlink broadcast signaling based on the network configuration;
not initiating a random access procedure;
determining whether to initiate the random access procedure based on the network configuration;
receiving a downlink periodic signal based on a fifth period, wherein the fifth period is greater than a period in which the UE receives the downlink periodic signal during the Active time of DTX of the base station; and
transmitting an uplink periodic signal based on a sixth period, wherein the sixth period is greater than a period in which the UE transmits the uplink periodic signal during the Active time of DTX of the base station.

13. A method performed by a base station in a communication system, the method comprising:
performing at least one of:
transmitting or receiving a signal based on at least two kinds of periods;
setting the signal as mute state at a specific occasion, and not transmitting or receiving the signal at the specific occasion; or
transmitting discontinuous transmission (DTX) configuration information, wherein the DTX configuration information is associated with at least one of an active time of DTX or a non-active time of DTX of the base station.

14. A user equipment (UE) in a communication system, the UE comprising:
a transceiver; and
a processor coupled to the transceiver and configured to:
determine at least two kinds of periods of a signal; and
receive or transmit the signal based on the at least two kinds of periods.

15. A base station in a communication system, the base station comprising:
a transceiver; and
a processor coupled to the transceiver and configured to:
perform at least one of:
transmitting or receiving a signal based on at least two kinds of periods;
setting the signal as mute state at a specific occasion, and not transmitting or receiving the signal at the specific occasion; or
transmitting discontinuous transmission (DTX) configuration information, wherein the DTX configuration information is associated with at least one of an active time of DTX or a non-active time of DTX of the base station.
